(19) United States
(12) Patent Application Publication
(10) Pub. No.: US 2025/0368487 A1
(43) Pub. Date: Dec. 4, 2025

(54) Lifting Assembly Mounted Rotator and Payloads for Bulk Material

(71) Applicant: Halliburton Energy Services, Inc., Houston, TX (US)

(72) Inventor: Chad A. Fisher, Cache, OK (US)

(73) Assignee: Halliburton Energy Services, Inc., Houston, TX (US)

(21) Appl. No.: 18/676,070

(22) Filed: May 28, 2024

(51) Int. Cl. B66F 9/12

(52) U.S. Cl. CPC B66F 9/125

(57) ABSTRACT

A system includes a lifting vehicle comprising a lifting assembly and a payload rotating device. The payload rotating device includes a support shaft configured to non-rotatingly mount to the lifting assembly and is vertically movable by the lifting assembly. The payload rotating device also incudes a sleeve including a sleeve external surface including a non-circular profile, wherein the sleeve is disposed about the support shaft. The payload rotating device also invludes a rotary actuator attached to the support shaft and the sleeve such that when the rotary actuator is actuated, the sleeve rotates about the support shaft. The system also includes a payload including a channel passing through a containment volume of the payload that includes an internal profile configured to engage with the non-circular profile of the sleeve to prevent rotation of the payload relative to the sleeve.

### BACKGROUND

Drilling and completing a wellbore to recover oil and gas from a subterranean formation involves a series of construction steps designed to extract hydrocarbons efficiently and safely. The process typically begins with the selection of a drilling location based on geological studies and seismic data analysis. Once the drilling site is identified, a drilling operation commences with the drilling of the wellbore, which involves the use of a drill bit attached to the bottom of a drill string. The drill string is typically rotated, and a drilling mud, e.g., a combination of water, weighting materials, and additives, is circulated down the drill string and back up the annular space between the drill string and the wellbore walls. Once the selected depth is reached, the drilling phase of the wellbore construction process is completed, and the wellbore can be isolated from wellbore fluids.

The wellbore construction process can include a wellbore stimulation operation, e.g., hydraulic fracturing, to create a flow path for the hydrocarbons. For example, the wellbore can be opened to an oil-bearing formation, for example, with a perforating gun and the wellbore stimulation operation can pump a fracturing fluid, e.g., water and sand, at a high pressure and flowrate to crack or fracture the formation and deposit sand into the cracks. The sand can prop open the fractures within the hydrocarbon bearing formation and provide a pathway to the casing string. The pumping operation can utilize large volumes of water and sand during the wellbore stimulation operation.

Recent developments in bulk material handling operations involve the use of portable containers for transporting bulk material such as sand from a mining location to the wellsite. The bulk material, e.g., sand, can be wet or can include a high-water content. These portable containers can be brought in on trucks, unloaded from the trucks, stored on location, and manipulated about the wellsite when the material is to be used. The portable containers dispense the bulk materials onto a mechanical conveying system, e.g., conveyor belt, auger, bucket lift, etc., to move the material to a determined destination at the wellsite. Dispensing bulk materials from the portable containers may require an inversion of the portable container, which presents engineering challenges regarding the lifting vehicles (e.g., forklifts) used to lift and rotate the containers.

While forklifts are nearly universally equipped to raise and lower heavy items, rotating of the items often requires specialized equipment or devices, which often have a series of drawbacks. Such drawbacks include a reduced weight or size capacity to correctively account for moments and torques that a forklift may not be subjected to when raising and lowering items alone.

Known solutions for rotating containers or other large items by way of a forklift often include devices configured to attach to the mast of a forklift, and often include forks attached to a rotating mechanism. A rotating fork device includes a number of drawbacks. Firstly, the rotating mechanism is disposed between the mast of the forklift and the forks, which increases the distance between the mast and the load carried on the forks. This distance increases the torque applied to the mast by the load, and thus reduces the maximum lift capacity of the forklift. Secondly, the forks are configured to lift and rotate the load from the bottom of the load. When the load is rotated from the bottom, a center of gravity of the load is no longer aligned with the lifting force of the forks. This misalignment of the lifting force and the weight generates torques at the forks that also reduce the lift capacity of the forklift. Furthermore, the rotating fork devices often possess limited ranges of rotation, increasing the difficulty of executing certain tasks, such as inverting a container.

### BRIEF DESCRIPTION OF THE DRAWINGS

FIGS. 1A-1D illustrate force diagrams of a forklift rotating a load from an external point of the load, according to embodiments of the present disclosure.

FIGS. 2A-2D illustrate force diagrams of a forklift rotating a load form the center of gravity of the load, according to embodiments of the present disclosure.

FIG. 3 illustrates a container rotating device, according to embodiments of the present disclosure.

FIG. 4 illustrates a container, according to embodiments of the present disclosure.

FIG. 5 illustrates a side section view of a container rotating device engaged with a container, according to embodiments of the present disclosure.

FIGS. 6A-6C illustrate embodiments of container rotating devices mounted on lifting vehicles and engaged with containers, according to embodiments of the present disclosure.

FIGS. 7A-7C illustrate a lifting vehicle inverting a container with a container rotating device, according to embodiments of the present disclosure.

### DETAILED DESCRIPTION

The present disclosure provides container rotating devices and containers for bulk materials to be rotated by the same. Methods and devices for rotating loads carried by forklifts, or other lifting vehicles, often result in substantial reduction of the load capacity of the lifting vehicle. This reduction in capacity is due to misalignment of lifting forces applied to the load and the weight force of a load when rotated. This misalignment can create unwanted torques on both the lifting vehicle and the load, which are to be accounted for in determining the load capacity of the lifting vehicle.

Provided herein are devices for rotating loads, specifically containers for bulk materials, on a lifting vehicle by applying the lifting force at the center of gravity of the container, and rotating the container about the center of gravity, such that the lifting force and the weight force are substantially aligned at all indices of rotation. Alignment of the weight forces and lifting forces prevents unwanted torques in the plane of rotation. Furthermore, the devices may be configured such that the load borne by the lifting vehicle abouts the mast of the lifting vehicle, which may reduce static torques applied to the mast.

Additional features and advantages of the disclosed method and apparatus are described in, and will be apparent from, the following Detailed Description and the Figures. The features and advantages described herein are not all-inclusive and additional features and advantages will be apparent to one of ordinary skill in the art in view of the figures and description. Moreover, it should be noted that the language used in the specification has been principally selected for readability and instructional purposes, and not to limit the scope of the inventive subject matter.

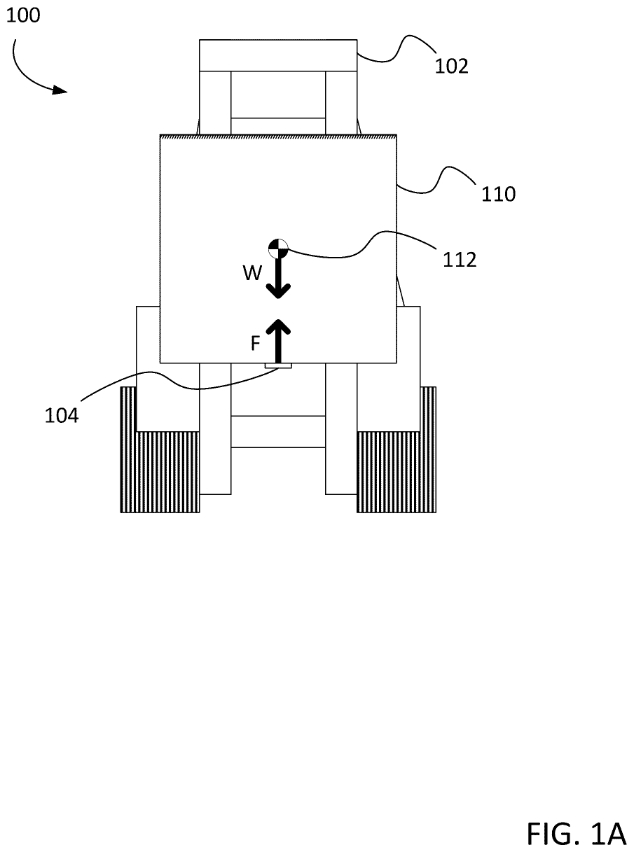

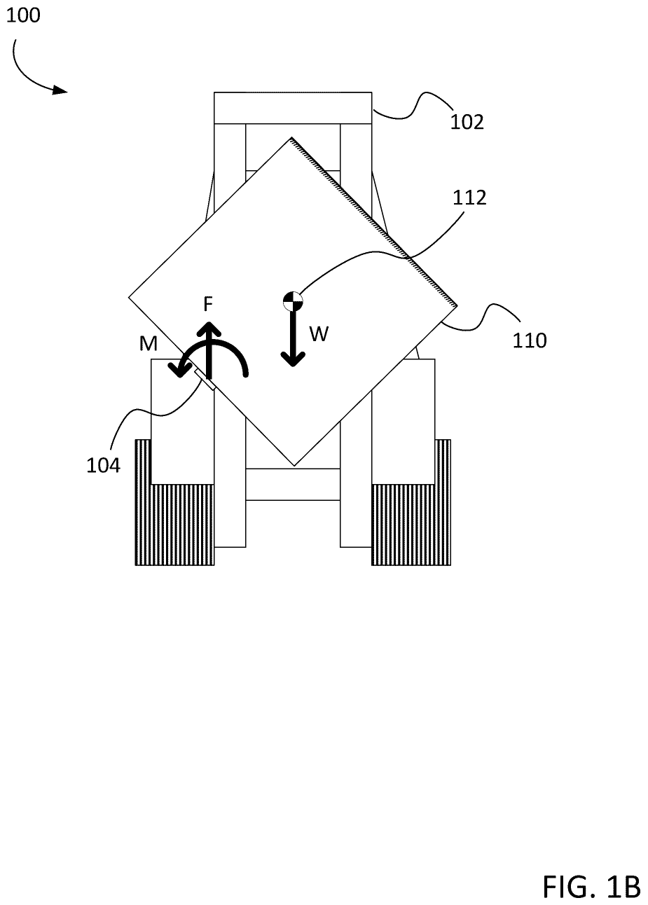

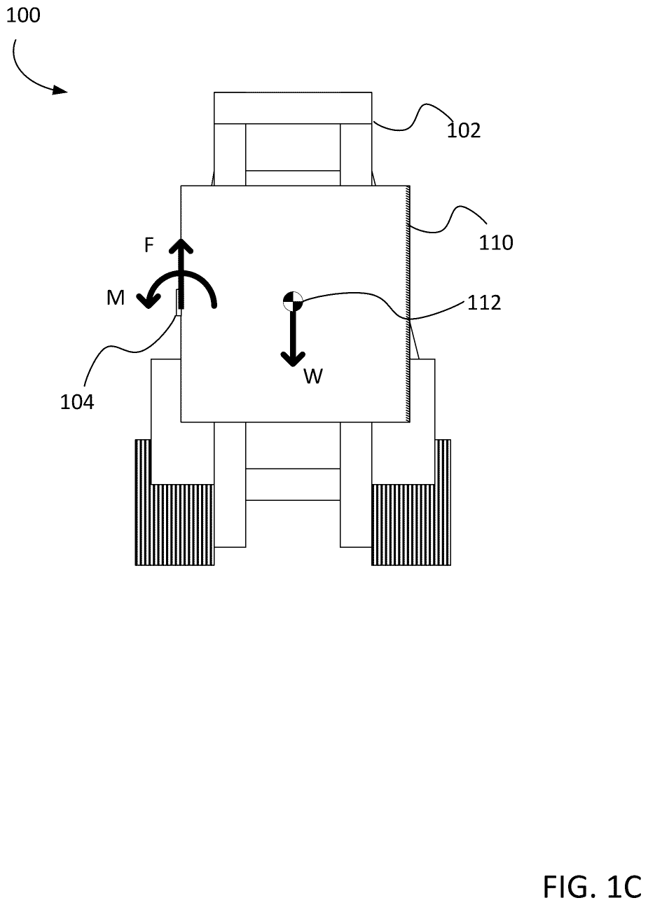

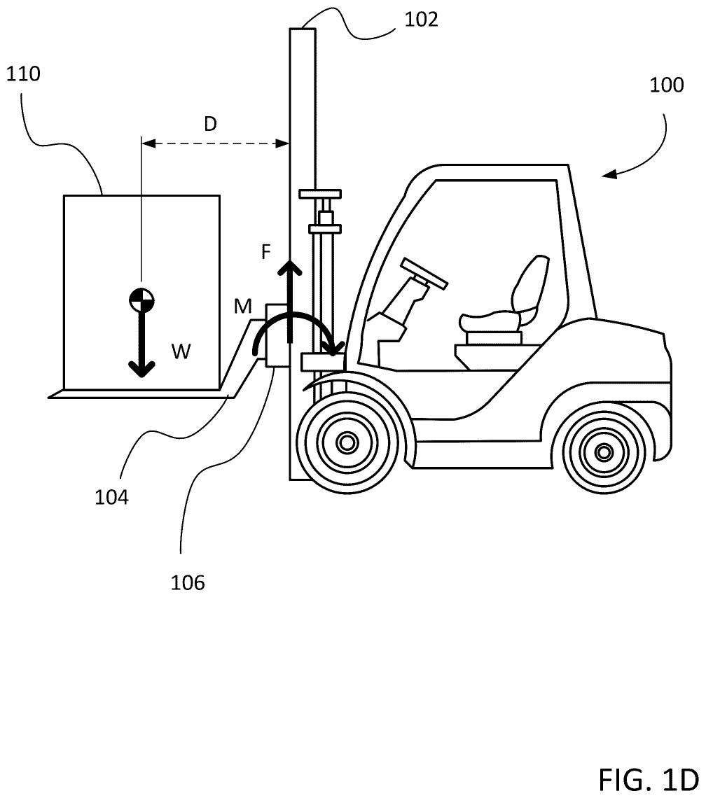

FIGS. 1A-1C illustrate simplified static force diagrams of a lifting vehicle (e.g., forklift) 100 rotating a load 110 that has been lifted, intended to illustrate the above-described concepts, according to embodiments of the present disclosure.

FIG. 1A illustrates a static force diagram when the lifting vehicle 100 has lifted the load 110, and the load 110 is at 0 degrees of rotation. The load 110 has a weight W, which is a force that acts in the direction of gravity at the center of gravity 112 of the load 110. The weight W of the load 110 is counteracted by a lifting force F, applied at the bottom of the load 110 by a lifting implement 104. The lifting implement 104 is intended to represent a simplified example of a rotating fork device as referenced above, and has been simplified to apply the lift force from one point instead of two points, but relevant physical principles are not affected by the simplification. When the load 110 is subject to 0 degrees of rotation, the lifting force F is aligned with the weight W, such that the forces are balanced, and there is no net torque about the center of gravity 112 of the load 110.

FIG. 1B illustrates the static force diagram when the lifting vehicle 100 has lifted the load 110 and rotated the load 110 45 degrees relative to the position of FIG. 1A, according to embodiments of the present disclosure. When the load 110 is subject to rotation, the lifting force F is misaligned with the weight W, such that the forces are balanced with respect to magnitude, but there is a net torque about the center of gravity 112 of the load 110. The lifting implement 104 now applies a counter-torque M to account for the misalignment of the lifting force F and the weight W such that all forces and torques are balanced. The counter-torque M transfers additional stresses to the mast 102 of the lifting vehicle 100 where the lifting implement attaches, which reduce the overall capacity of the lifting vehicle 100.

FIG. 1C illustrates the static force diagram when the lifting vehicle 100 has lifted the load 110 and rotated the load 110 90 degrees relative to the position of FIG. 1A, according to embodiments of the present disclosure. As in FIG. 1B, the lifting force F is misaligned with the weight W, such that the forces are balanced with respect to magnitude, and there is a net torque about the center of gravity 112 of the load 110. The lifting implement 104 applies a counter-torque M, where the counter-torque M has increased in magnitude from FIG. 1B, to account for the misalignment of the lifting force F and the weight W, such that forces and torques are balanced. The counter-torque M transfers further additional stresses to the mast 102 of the lifting vehicle 100 where the lifting implement attaches, which reduce the overall capacity of the lifting vehicle 100.

FIG. 1D illustrates a static force diagram of the side profile of the lifting vehicle 100 when the lifting vehicle 100 has lifted the load 110, and the load 110 is at 0 degrees of rotation according to embodiments of the present disclosure. The lifting implement 104 may include a rotating mechanism 106 disposed between the load 110 and the mast 102. The rotating mechanism 106 increases a distance D between the mast 102 and the center of gravity of the load 110. As the force F (applied by the mast 102 on the lifting implement 104) and the weight W of the are not aligned, the mast 102 also applies a counter-torque M to the lifting implement 104 to balance the forces and torques. The counter-torque M transfers further additional stresses to the mast 102 of the lifting vehicle 100 where the lifting implement attaches, which reduce the overall capacity of the lifting vehicle 100. The magnitude of the counter-torque M varies proportionally with the distance D. Thus, by reducing the distance D, the magnitude of the counter-torque M may be decreased.

According to embodiments of the present disclosure, a rotating device may be implemented to lift and invert a load which may reduce the effects of the torques described above. By configuring the load and the rotating device to facilitate lifting and rotating the load at the center of gravity of the load, the load may be rotated without subjecting the lifting vehicle to variable torques as the container is rotated.

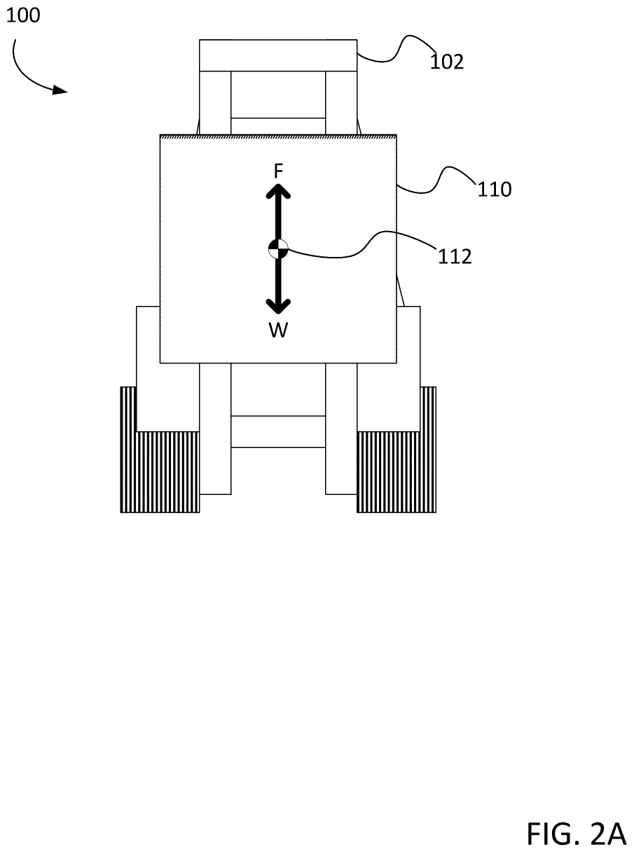

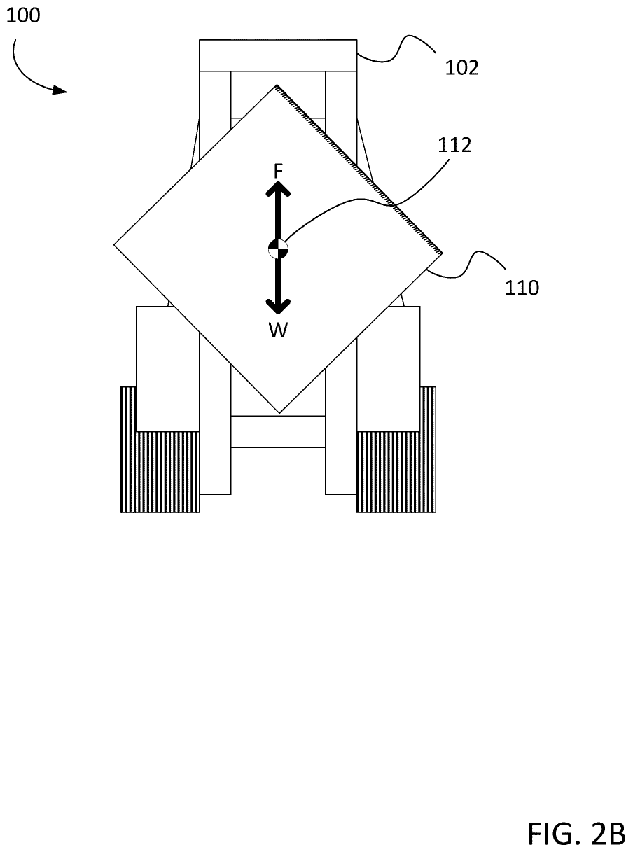

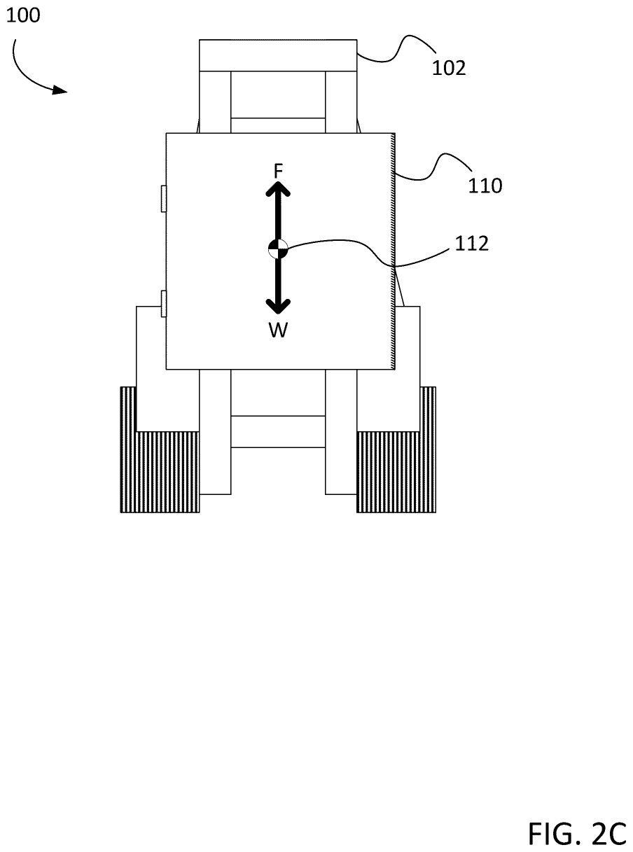

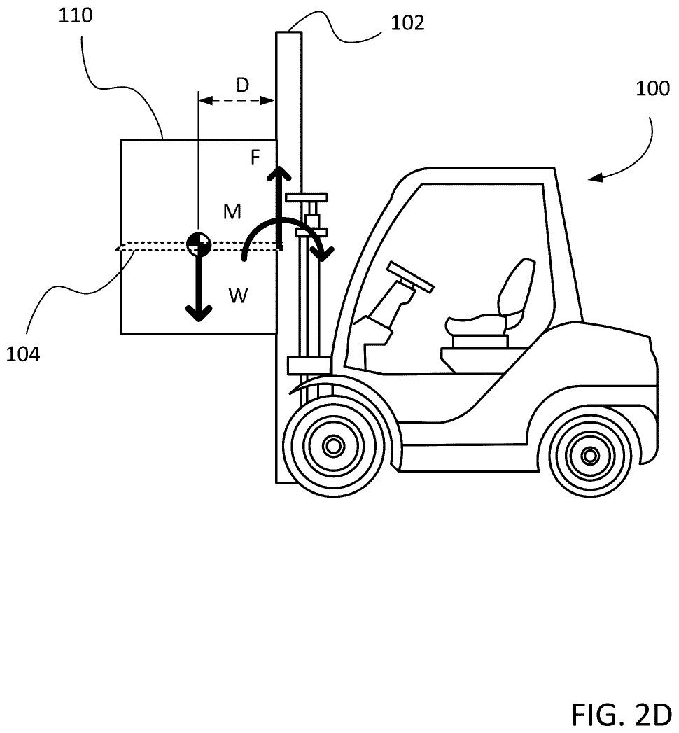

FIGS. 2A-2C illustrate simplified static force diagrams of a lifting vehicle (e.g., forklift) 100 rotating a lifted load 110 (e.g. container, specialized container), intended to illustrate the above-described concepts, according to embodiments of the present disclosure.

FIG. 2A illustrates the static force diagram when the lifting vehicle has lifted the load 110, and the load 110 is at 0 degrees of rotation, according to embodiments of the present disclosure. The load 110 has a weight W, which is a force that acts in the direction of gravity at the center of gravity 112 of the load 110. The weight W of the load 110 is counteracted by a lifting force F, which is also applied at a center of gravity 112 of the load 110 (e.g., applied by a rotating device). When the load 110 is subject to 0 degrees of rotation, the lifting force F is aligned with the weight W, such that the forces are balanced, and there is no net torque about the center of gravity 112 of the load 110.

FIG. 2B illustrates the static force diagram when the lifting vehicle has lifted the load 110 and rotated the load 110 45 degrees relative to the position of FIG. 2A, according to embodiments of the present disclosure. When the load 110 is rotated, as the lifting force F is applied at the center of gravity 12, the force F and the weight W remain aligned and there is no net torque about the center of gravity 112 of the load 110, and the lifting capacity of the lifting vehicle 100 is not affected by the rotation.

FIG. 2C illustrates the static force diagram when the lifting vehicle has lifted the load 110 and rotated the load 110 90 degrees relative to the position of FIG. 2A, according to embodiments of the present disclosure. When the load 110 is rotated, as the lifting force F is applied at the center of gravity 12, the force F and the weight W remain aligned and there is no net torque about the center of gravity 112 of the load 110, and the lifting capacity of the lifting vehicle 100 is not affected by the rotation.

FIG. 2D illustrates a static force diagram of the side profile of the lifting vehicle 100 when the lifting vehicle 100 has lifted the load 110, and the load 110 is at 0 degrees of rotation according to embodiments of the present disclosure. FIG. 2D illustrates an embodiment in which the lifting implement 104 acts at the center of gravity of the load 110, and the load 110 abuts the mast 102, such that the distance D is effectively reduced, and theoretically minimized. As used herein, “abut” may indicate that two referenced components contact one another but may also indicate that the two components are proximate to one another such that the distance between the components is mathematically negligible, to allow for tolerances and rotation. When the distance D is at a theoretical minimum, the magnitude of counter torque M is also theoretically minimized, which is ideal, as a minimized counter-torque M corresponds to a maximized lift capacity of the lifting vehicle.

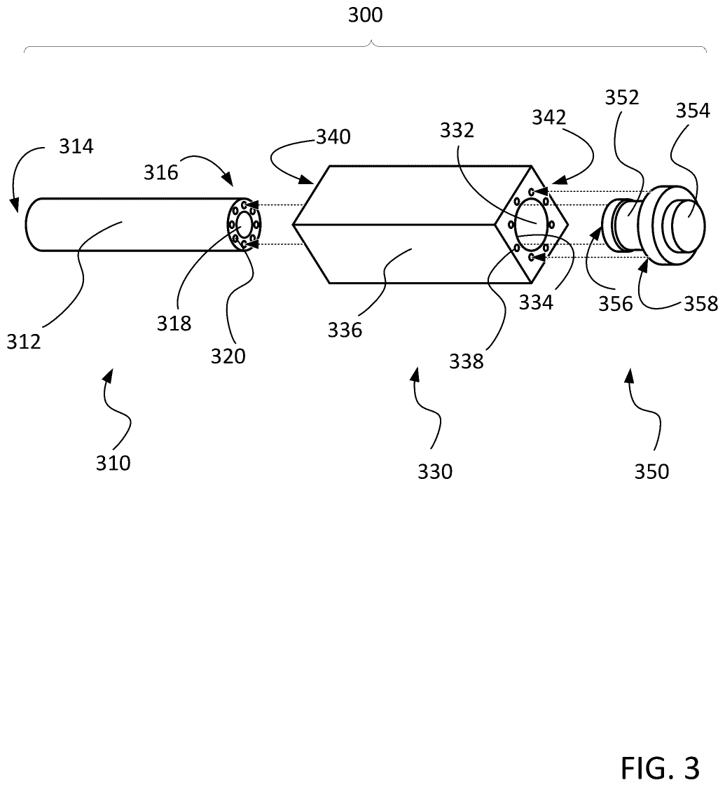

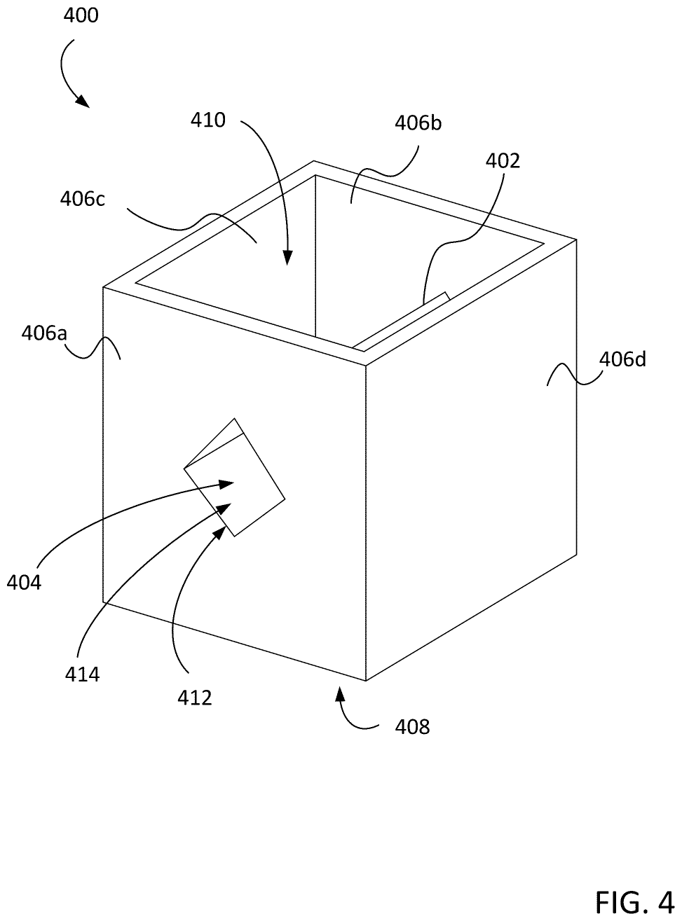

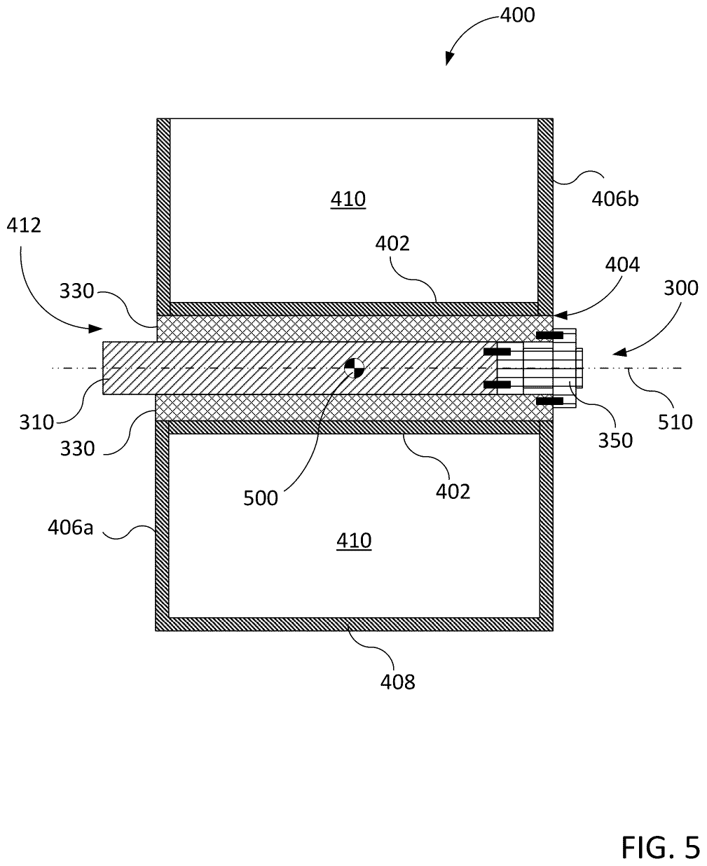

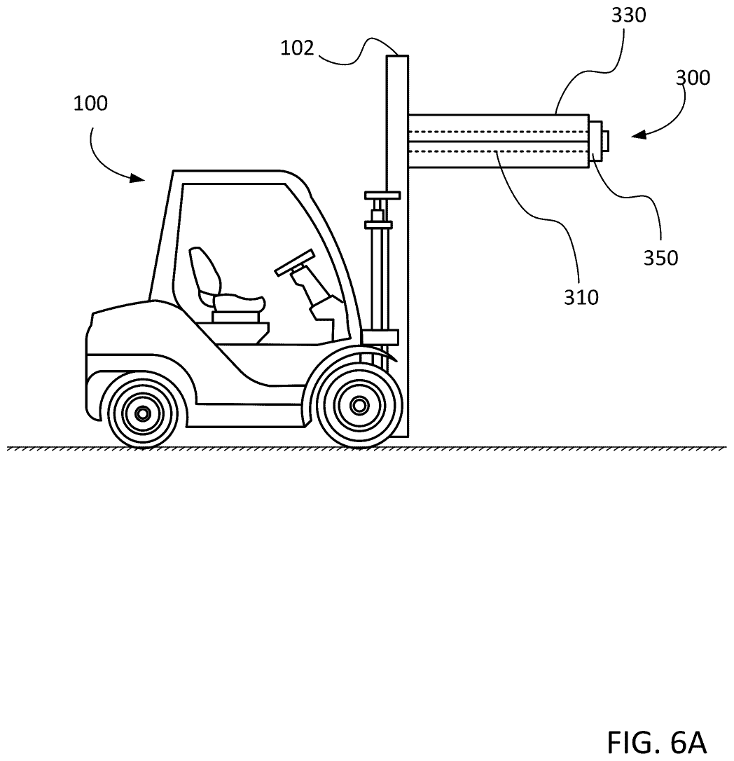

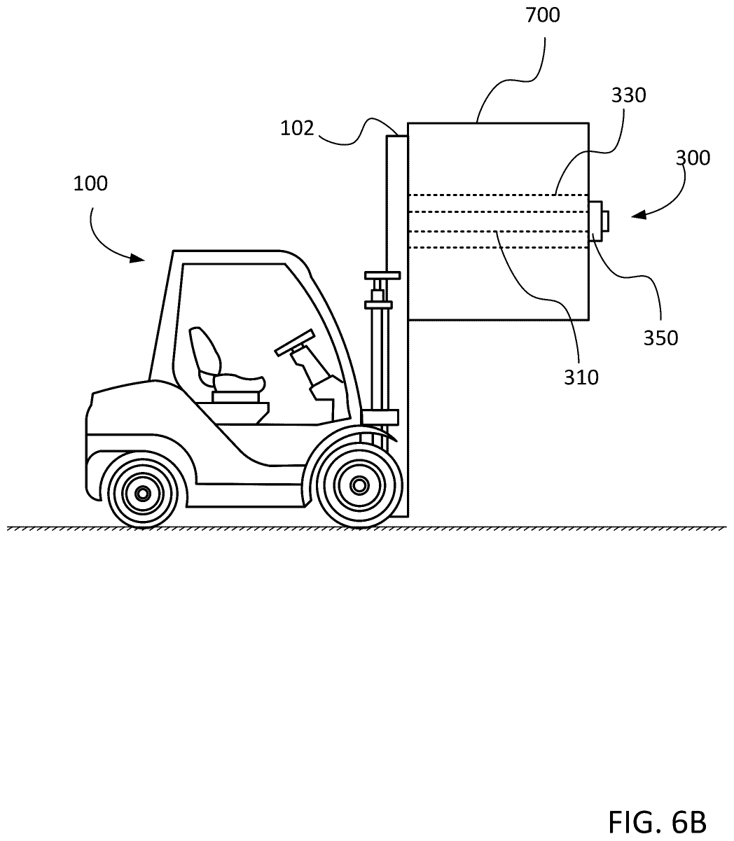

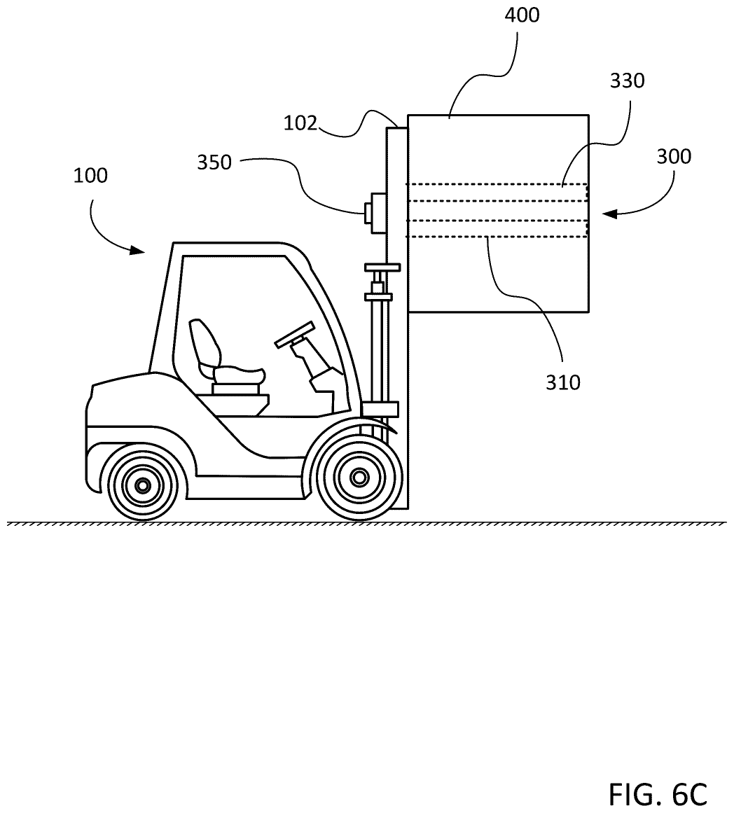

FIG. 3 illustrates an exploded view of a container rotating device 300 that relies upon the physical principles illustrated in FIGS. 2A-2D, according to embodiments of the present disclosure. The rotating device 300 includes a support shaft 310 (See also FIG. 4), a sleeve 330 (See also FIG. 5,) and a rotary actuator 350 (See also FIG. 6A). According to one or more embodiments, a support shaft 310 is configured such that the support shaft 310 may be affixed, attached, mounted, or otherwise secured such that the shaft does not rotate to a mast 102 of a lifting vehicle 100 in a substantially perpendicular manner and vertically moveable along the mast.

The support shaft 310 is substantially cylindrical, having a rounded shaft external surface 312, a proximal end having a substantially circular shaft proximal face 314, and a distal end having a substantially circular shaft distal face 316. In some examples the shaft external surface 312 is a bearing surface, configured to reduce friction between the support shaft 310 and the sleeve 330 when engaged with the sleeve 330. In some examples, the shaft external surface 312 is configured to interface with a separable bearing surface configured to be disposed between the shaft 310 and the sleeve 330.

In some examples, the support shaft 310 includes a conduit 318, which passes through the support shaft between the shaft proximal face 314 and the shaft distal face 316. The conduit 318 may be configured to provide space for electrical and hydraulic connections between the rotary actuator 350 and the lifting vehicle 100. The conduit 318 may have a diameter, or bore size, which is determined based on one or more factors. A larger bore diameter may provide for a reduction in material, of which the support shaft 310 is constructed, which reduces the weight of the rotating device 300, however the strength of the support shaft 310 is also reduced. In some examples, the conduit 318 may be several smaller conduits, containing hydraulic lines or electrical wires.

In some examples, the rotary actuator 350 is affixed to the shaft distal face 316 and the shaft distal face 316 includes hardware or features configured to facilitate the attachment of the rotary actuator 350 thereto, indicated in FIG. 3 by shaft fastener holes 320. Although illustrated as shaft fastener holes 320 in FIG. 4, this disclosure contemplates embodiments where the means of attachment between the shaft distal face 316 and the rotary actuator 350 includes fasteners, threaded connectors, hydraulic connections, electrical connections, or other means of attachment. This disclosure does not seek to differentiate between such means of attachment, nor limit the scope of the present technology thereby. In some examples, the means of attachment may be integrated into an opening of the conduit 318.

In some examples, the shaft proximal face 314 includes hardware or features configured to facilitate the non-rotating attachment of the support shaft 310, and thus the rotating device 300, to the mast 102 of a lifting vehicle 100. The attachment hardware may include fasteners, hooks, clamps, and other means of attachment; however, this disclosure does not seek to differentiate between such means of attachment, nor limit the scope of the present technology thereby. The mast 102 may include hardware or features configured to engage with the hardware or features of the shaft proximal face 314, which are configured such that the support shaft 310 may be secured to the mast 102 in a manner such that the support shaft 310 is does not rotate with respect to the mast 102. This disclosure further contemplates wherein the support shaft 310 is configured to interface with lifting vehicles 100 having lifting devices other than a mast 102 that are capable of providing lifting forces, such as an arm of a telehandler, as a non-limiting example.

In some examples, the rotary actuator 350 is affixed to the proximal face 314 of the support shaft 310. The shaft proximal face 314 includes hardware or features configured to facilitate the attachment of the rotary actuator 350 to the support shaft 310 (See FIG. 6C), as well as hardware or features configured to facilitate the attachment of the support shaft 310 to the mast 102 of a lifting vehicle 100. The hardware or features of the shaft proximal face 316 may be configured to engage with hardware or features of the rotary actuator 350 such that when the rotary actuator 350 is secured to the support shaft 310, the first portion 352 of the rotary actuator 350 does not rotate with respect to the support shaft 310.

The sleeve 306 is configured to be disposed around the support shaft 310, such that the sleeve is rotatable about the support shaft 310. The sleeve 306 includes a sleeve external surface 336 with a non-circular profile, which is configured to interface with a compatible container 400 (see FIG. 4 and discussion below). The sleeve 330 further includes a sleeve channel 332 disposed through the sleeve 330 that includes a sleeve internal surface 334 configured to engage with the shaft external surface 312 when engaged with the support shaft 310. The sleeve internal surface 334 in some examples is a bearing surface configured to reduce friction between the support shaft 310 and the sleeve 330. In some examples, the sleeve internal surface 334 is configured to interface with a separable bearing surface configured to be disposed between the shaft 310 and the sleeve 330.

As illustrated in FIG. 3, the non-circular profile of the sleeve 330 is substantially a square or rhomboid prism, defined between a sleeve proximal face 340 and a sleeve distal face 342 (generally or collectively, faces 340). In some examples, the faces 340 are dimensionally matched, (e.g. having the same shape and dimensions, substantially identical). However, in some examples, the faces 340 are not dimensionally matched, such that a taper is defined along the sleeve 330 from the sleeve proximal face 340 to the sleeve distal face 342. A tapered sleeve 330 may increase ease of use when inserting the rotating device 300 into a container 400. The shape (e.g., profile) of the faces 340 also corresponds to the shape of a channel 404 of the container 400 (See FIG. 4 and discussion below) and may be selected from one of several shapes. Although illustrated as square, the shape of the faces 340 may be any non-circular profile, although certain shapes may be disadvantageous for practical use purposes. As non-limiting examples, the shape of the faces 340 may be a regular polygon, an irregular polygon, a concave polygon, a convex polygon, a circle or polygon having an intruding portion or portions, a circle or polygon having a protruding portion or portions (e.g. gear shaped), or the like. Stated differently, the shape of the faces 340 may be configured such that the sleeve 330 is not rotatable with respect to the container 400 (See FIG. 4) when inserted therein.

The sleeve 330 may be a continuous prism, however, in some embodiments, the sleeve 330 may be a shaft defining the sleeve channel 332, having blocks of the shape of the faces 340 disposed intermittently along the shaft. Such a configuration may allow for reduced material costs when constructing the sleeve 330.

In some examples, the rotary actuator 350 is mounted on the shaft distal face 316 of the support shaft 310. In such examples, the sleeve distal face 342 includes hardware or features configured to facilitate the attachment of the rotary actuator 350 thereto, indicated in FIG. 3 by fastener holes 338. Although illustrated as fastener holes 338 in FIG. 3, this disclosure contemplates embodiments where the means of attachment between the sleeve distal face 342 and the rotary actuator 350 includes fasteners, threaded connectors, and other conventional means of attachment. This disclosure does not seek to differentiate between such means of attachment, nor limit the scope of the present technology thereby.

The rotary actuator 350 is affixable to an end of the support shaft 310 distal from the mast 102, and is also affixable to the sleeve 330, such that when the rotary actuator is actuated, the sleeve 330 rotates about the support shaft 310. The rotary actuator 350 may include a first portion 352 and a second portion 354, where the first portion 352 and second portion 354 are axially aligned and configured to rotate relative to one another when the rotary actuator 350 is actuated. In some examples, the first portion 352 is configured to attach to the support shaft 310, such that a first face 356 of the rotary actuator 350 interfaces with the shaft distal face 316. In some examples, the second portion 354 is configured to attach to the sleeve 330, such that a second face 358 of the rotary actuator 350 interfaces with the sleeve distal face 342. The means of connection between the rotary actuator 350 and the support shaft 310 may be as discussed in reference to FIG. 3 The means of connection between the rotary actuator 350 and the sleeve 330 may be as discussed in reference to FIG. 3. In some examples, the rotary actuator 350 may be a hydraulic rotary actuator, and in other examples the rotary actuator 350 may be an electric rotary actuator. In some examples, the connections to power the rotary actuator 350 are provided through the conduit 318 of the support shaft 310 from the lifting vehicle 100.

FIG. 4 illustrates a container 400 which is compatible with the rotating device 300, according to embodiments of the present disclosure. The container 400 defines a container volume 410 bounded by container walls 406a-d (generally or collectively, container walls 406) and a container bottom 408. The container 400 further includes a channel 404 defined into a first container wall 406, where the channel 404 includes a channel internal surface 414 including a channel internal profile configured to engage with the non-circular profile of the sleeve external surface 336 such that the rotating device 300 may be inserted into the channel 404. In this regard, the channel 404 may be considered keyed to the sleeve 330, or vice versa. In some examples, the fit between the rotating device 300 and the channel 404 is a clearance fit, and possesses the corresponding clearances defined in the American National Standard Preferred Hole Basis Metric Clearance Fits (ANSI B4.2-1978 (R2004)).

The shape of the channel opening 412 corresponds to the non-circular profile of the sleeve 330 and may be selected from one of several shapes. Although illustrated as square, the shape of the channel 404 may be any non-circular shape, although certain shapes may be disadvantageous for practical use purposes. As non-limiting examples, the shape of the channel 404 may be a regular polygon, an irregular polygon, a concave polygon, a convex polygon, a circle or polygon having an intruding portion or portions, a circle or polygon having a protruding portion or portions (e.g. gear shaped), or the like. Stated differently, the shape of the channel 404 may be configured such that the sleeve 330 is not operable to rotate with respect to the container 400 when inserted therein.

In some examples, the container 400 is an open top container, and does not include a top surface, or wall opposed to the container bottom 208. In other examples, the container 400 includes a lid or some other device to cover the top of the container 400.

In some examples, the channel 404 is bounded by channel walls 402 where the channel extends into the container volume 410, such that the channel 404 is physically isolated from any contents or materials disposed within the container volume 410. Furthermore, the channel walls 402 may provide structural support for the container 400, which may increase the structural integrity of the container 400 when the container is rotated by the rotating device 300 compared to a container 400 not having a channel.

In some examples, the channel 404 is defined from a first container wall 406a through the container volume 410 to an opposing container wall 406b, where the channel is orthogonal to both container walls 406a and 406b. However, in some examples, the channel 404 does not extend from a first container wall 406a to a second container wall 406b, but rather extends from the first container wall 406 and terminates within the container volume 410.

While the focus of this disclosure is directed towards containers (e.g., container 400) and devices by which to rotate containers (e.g., rotating device 300), this disclosure contemplates other payloads having compatible channels passing through the body of the payload, similar to embodiments of channel 404 that maybe functionally compatible with the rotating device 300. In some examples, the container 400 in various states of being filled, may be regarded or referred to generally as a payload.

FIG. 5 illustrates a side cross sectional view of a system including a container 400 engaged with a rotating device 300, according to embodiments of the present disclosure. In some examples, the channel 404 of the container 400 passes through a center of gravity 500 of the container 400, such that the container 400 may be rotated by the rotating device as described in the example of FIGS. 2A-2C. The channel opening 412 may be disposed on the first container wall 406a at a location aligned with the center of gravity 500 of the container 400. In some examples, the center of area of the container wall 406a corresponds to a two-dimensional location aligned with the center of gravity of the container 400, and the channel opening 412 may be disposed proximately to the center of area of the container. In some examples, the channel 404 is configured relative to the center of gravity 500 of the container 400 when the container 400 is empty. In other examples, the channel 404 is configured relative to the center of gravity 500 of the container 400 when the container 400 is filled to a certain fill level with a predetermined material of a known density.

In some examples, the channel 404 may be configured such that a rotational axis 510 (e.g., the axis about which the container 400 rotates when rotated by the rotating device 300) intersects with the center of gravity 500 of the container 400. In other examples, the channel 404 may be configured such that the rotational axis 510 passes within a predetermined distance of the center of gravity 500 of the container 400. In some examples, the distance between and the rotational axis 510 and the center of gravity 500 of the container 400 is a distance less than 10 percent of a lateral or longitudinal length (e.g., side length, side height) of a container wall 406. In some examples, the distance between and the rotational axis 510 of the channel 404 and the center of gravity 500 of the container 400 is a distance less than 5 percent of a lateral or longitudinal length of a container wall 406.

In some examples, the channel 404 may be configured such that the rotational axis of the channel 404 is above (e.g., relative to gravity) the center of gravity of the container 400, which may reduce a propensity of the container 400 to tip when lifted by the lifting vehicle 100, thus reducing torque on the rotating device 300 when the lifting vehicle 100 is in transit, or otherwise not rotating the container 400.

In some examples, the channel 404 may be configured such that the rotational axis of the channel 404 is below (e.g., relative to gravity) the center of gravity of the container 400, which may reduce the power required by the rotary actuator 350 to rotate the container 400, as gravitational forces may produce a torque that aids in the rotation of the container 400.

FIGS. 6A-6C illustrate side views of the rotating device 300 mounted to the mast 102 of a lifting vehicle 100, according to embodiments of the present disclosure. In FIG. 6A, the rotary actuator 350 is affixed to the shaft distal face 316 of the support shaft 310. The rotating device 300 may be secured to the mast 102 of a lifting vehicle 100 such that the shaft 310 does not rotate relative to the mast 102, and the rotating device may be moved vertically along the mast 102.

In FIG. 6B, the rotary actuator 350 is affixed to the shaft distal face 316 of the support shaft 310. The rotating device 300 may be secured to the mast 102 of a lifting vehicle 100 such that the shaft 310 does not rotate relative to the mast 102, and the rotating device may be moved vertically along the mast 102. The rotating device 300 is inserted into the channel 404 of a container 400, at which point lifting mechanisms in the mast 102 may be engaged to lift the container 400 off the ground. In some examples, the rotating device 300 is configured such that the container wall 406 may abut the mast 102 of the lifting vehicle 100 when the rotating device 300 is engaged with the container. Such a configuration may reduce an applied torque at the attachment point of the shaft proximal face 314 to the mast 102. When the applied torque at the mast is reduced, an overall load capacity of the lifting vehicle 100 may be increased, due to a minimization of stresses resulting from the applied torque. As can be determined from comparison to FIGS. 1D and 2D, the rotating device 300 reduces the torque applied to the mast 102 by the rotating device by reducing the distance between the container 400 and the mast 102.

FIG. 6C illustrates an embodiment where the rotary actuator 350 is affixed to the shaft proximal face 314 of the support shaft 310, according to embodiments of the present disclosure. In such a configuration, the rotary actuator 350 is disposed on the other side of (relative to the container 400) the mast 102 (e.g., on an opposite side of the mast 102) so as not to increase a distance between the container 400 and the mast 102. In maintaining the container 400 close to the mast 102, the torque applied at the attachment point of the shaft proximal face 314 to the mast 102 is not increased relative to the embodiments of FIGS. 6A and 6B.

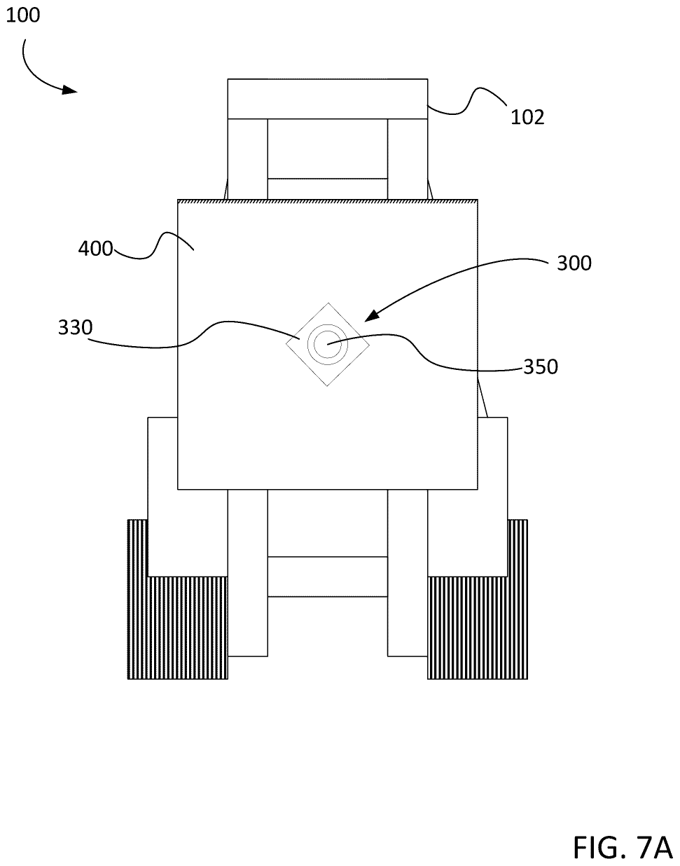

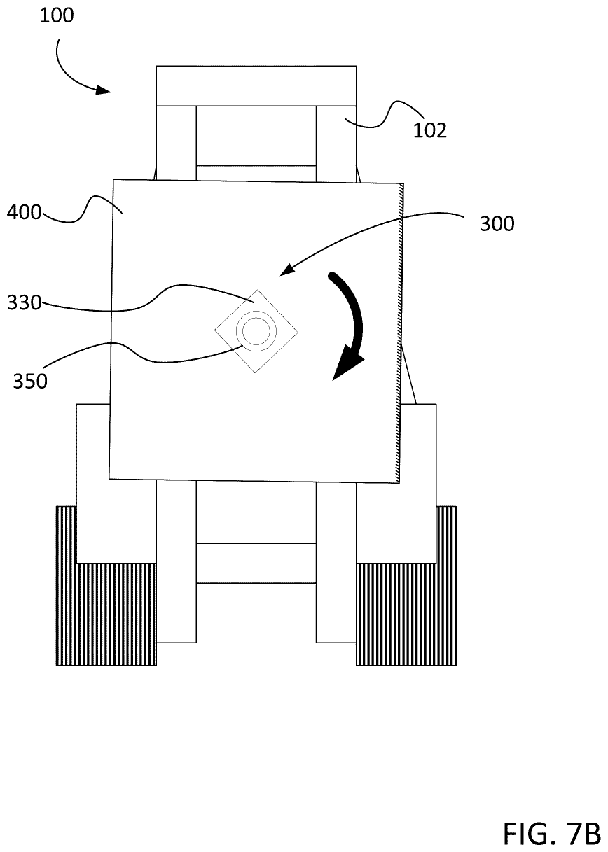

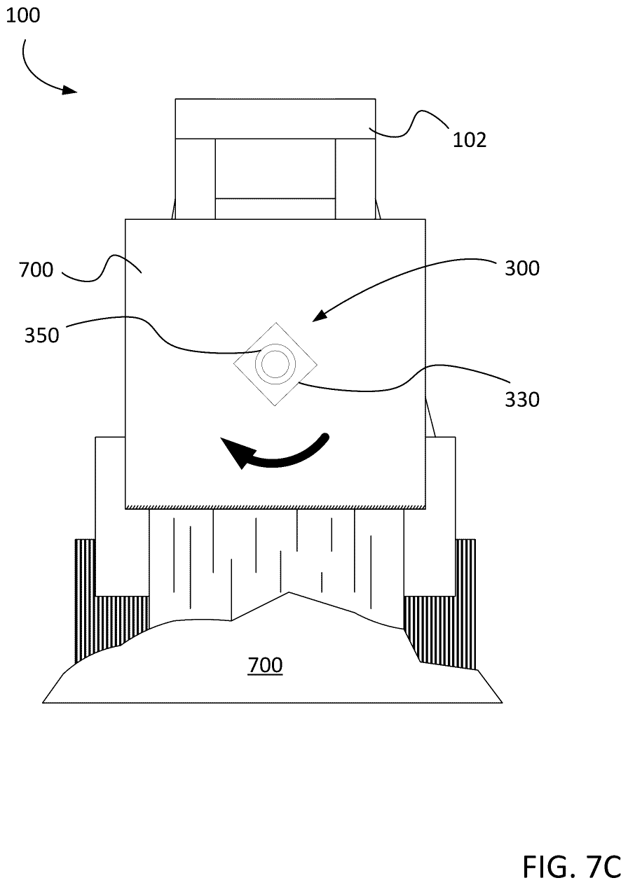

FIGS. 7A-7C illustrate a lifting vehicle 100 rotating a container 400 using a rotating device 300. FIG. 7A depicts the container at 0 degrees or rotation, FIG. 7B illustrates the container 400 at 90 degrees of rotation, and FIG. 7C illustrates the container 400 at 180 degrees of rotation, or, a full inversion, such that the material 700 contained in the container 400 may be dumped. As can be determined by comparison to FIGS. 2A-2C, the rotating device 300 reduces torque applied by the container 400 to the lifting vehicle 100 by lifting and rotating the container 400 at or near the center of gravity 500 of the container 400. In some examples, the rotating device 300 is also operable to rotate the container 400 360 degrees relative to a starting position.

The rotating device 300 is operable to reduce the torques applied to the mast 102 of a lifting vehicle 100 in two planes. The first plane torque is reduced by rotating the container 400 about the center of gravity 500, as illustrated in FIGS. 7A-7C. The second plane torque is reduced by decreasing the distance between the container 400 and the mast 102 as illustrated in FIGS. 6A-6C. In conjunction, the reduction of the first plane torque and the second plane torque may provide for an increased overall capacity for a lifting vehicle 100 to both lift and rotate a container 400.

Examples of the above aspects include:

Example 1 is a system comprising: a vehicle comprising a lifting assembly; a payload rotating device, including a support shaft configured to mount to the lifting assembly such that the support shaft does not rotate and is vertically moveable the lifting assembly. The payload rotating device also comprises a sleeve including a sleeve external surface including a non-circular profile, wherein the sleeve is disposed about the support shaft. The payload rotating device also comprises a rotary actuator attached to the support shaft and the sleeve such that when the rotary actuator is actuated, the sleeve rotates about the support shaft. The system also comprises a payload including a channel passing through a body of the payload, wherein the channel configured to receive the payload rotating device when inserted into the channel from outside the payload, the channel also including an internal profile configured to engage with the non-circular profile of the sleeve to prevent rotation of the payload relative to the sleeve. Wherein actuation of the rotary actuator rotates the sleeve and the payload about the support shaft when the payload rotating device is inserted into the payload.

Example 2 includes all the previous examples, wherein the channel is disposed on the payload such that a center of gravity of the payload is aligned with an axis of the channel.

Example 3 includes all the previous examples, wherein the channel is disposed on the payload such that a center of gravity of the payload is disposed within a predetermined distance from an axis of the channel.

Example 4 includes all the previous examples, wherein the non-circular profile is selected from a group of shapes consisting of: a regular polygon, an irregular polygon, a polygon having one or more protruding portions, a polygon having one or more intruding portions, a circle having one or more protruding portions, and a circle having one or more intruding portions.

Example 5 includes all the previous examples, wherein the payload rotating device is configured such that when the payload rotating device is mounted to the lifting vehicle, the rotary actuator is disposed on an opposite side of the support shaft relative to a side of the support shaft attached to the lifting assembly of the lifting vehicle.

Example 6 includes all the previous examples, wherein the payload rotating device is configured such that when the payload rotating device is mounted to the lifting vehicle, the rotary actuator is disposed on an opposite side of the lifting assembly of the lifting vehicle relative to the support shaft.

Example 7 includes all the previous examples, wherein the payload rotating device is configured such that the payload abuts the lifting assembly of the lifting vehicle when the payload rotating device is mounted on the lifting assembly of the lifting vehicle and the payload rotating device is inserted into the payload.

Example 8 includes all the previous examples, wherein the payload rotating device is operable to rotate the payload at least 90 degrees when the payload rotating device is mounted on the lifting assembly of the lifting vehicle and the payload rotating device is inserted into the payload.

Example 9 includes all the previous examples, wherein the support shaft includes or interfaces with a bearing surface configured to reduce friction between the support shaft and the sleeve.

Example 10 includes all the previous examples, wherein the sleeve includes or interfaces with a bearing surface configured to reduce friction between the sleeve and the support shaft.

Example 11 is a payload rotating device for mounting to a lifting assembly of a vehicle, including: a support shaft configured to mount to the lifting assembly such that the support shaft does not rotate; a sleeve including sleeve external surface having a non-circular profile, wherein the sleeve is disposed about the support shaft; and a rotary actuator attached to the support shaft and the sleeve such that when the rotary actuator is actuated, the sleeve rotates about the support shaft.

Example 12 includes all the previous examples, wherein the support shaft includes or is interfaces with a bearing surface configured to reduce friction between the support shaft and the sleeve.

Example 13 includes all the previous examples, wherein the sleeve includes or interfaces with a bearing surface configured to reduce friction between the sleeve and the support shaft.

Example 14 includes all the previous examples, wherein the non-circular profile is selected from a group of shapes consisting of: a regular polygon, an irregular polygon, a polygon having one or more protruding portions, a polygon having one or more intruding portions, a circle having one or more protruding portions, and a circle having one or more intruding portions.

Example 15 includes all the previous examples, configured to interface with a payload including a channel passing through a body of the payload, wherein the channel is configured to receive the container rotating device when inserted into the channel from outside the payload, the channel also including an internal profile configured to engage with the non-circular profile of the sleeve to prevent rotation of the payload relative to the sleeve, and wherein actuation of the rotary actuator rotates the sleeve and the container about the support shaft when the container rotating device is inserted into the container.

Example 16 is a payload, comprising a containment volume defined by payload walls and a channel defined through the payload walls and the containment volume, the channel including a non-circular internal profile.

Example 17 includes all the previous examples, wherein a center of gravity of the payload is aligned with an axis of the channel.

Example 18 includes all the previous examples, wherein the channel is disposed on the payload such that a center of gravity of the payload is disposed within a predetermined distance from the channel.

Example 19 is a method of rotating a payload comprising: affixing a payload rotating device to a lifting assembly of a vehicle, a support shaft of the payload rotating device not being rotatable relative to the lifting assembly; disposing a sleeve about the support shaft, the sleeve including a sleeve external surface including a non-circular profile; inserting the support shaft and sleeve into a channel of the payload, the channel including an internal profile configured to engage with the non-circular profile of the sleeve to prevent rotation of the payload relative to the sleeve; and rotating the payload by actuating a rotary actuator of the payload rotating device to rotate the sleeve relative to the support shaft.

Example 20 includes all the previous examples, wherein inserting the support shaft into the channel of the payload further includes positioning the payload such that the payload abuts the lifting assembly of the vehicle.

Certain terms are used throughout the description and claims to refer to certain features or components. As one skilled in the art will appreciate, different persons may refer to the same feature or component by different names. This document does not intend to distinguish between components or features that differ in name but not function.

As used herein, “about,” “approximately” and “substantially” are understood to refer to numbers in a range of the referenced number, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

Without further elaboration, it is believed that one skilled in the art can use the preceding description to use the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112 (f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

The invention is claimed as follows:

1. A system comprising:
a vehicle comprising a lifting assembly;
a payload rotating device, including:
a support shaft configured to mount to the lifting assembly such that the support shaft does not rotate and is vertically moveable the lifting assembly;
a sleeve including a sleeve external surface including a non-circular profile, wherein the sleeve is disposed about the support shaft; and
a rotary actuator attached to the support shaft and the sleeve such that when the rotary actuator is actuated, the sleeve rotates about the support shaft; and
a payload including a channel passing through a body of the payload, wherein the channel configured to receive the payload rotating device when inserted into the channel from outside the payload, the channel also including an internal profile configured to engage with the non-circular profile of the sleeve to prevent rotation of the payload relative to the sleeve, and
wherein actuation of the rotary actuator rotates the sleeve and the payload about the support shaft when the payload rotating device is inserted into the payload.

2. The system of claim 1, wherein the channel is disposed on the payload such that a center of gravity of the payload is aligned with an axis of the channel.

3. The system of claim 1, wherein the channel is disposed on the payload such that a center of gravity of the payload is disposed within a predetermined distance from an axis of the channel.

4. The system of claim 1, wherein the non-circular profile is selected from a group of shapes consisting of: a regular polygon, an irregular polygon, a polygon having one or more protruding portions, a polygon having one or more intruding portions, a circle having one or more protruding portions, and a circle having one or more intruding portions.

5. The system of claim 1, wherein the payload rotating device is configured such that when the payload rotating device is mounted to the lifting vehicle, the rotary actuator is disposed on an opposite side of the support shaft relative to a side of the support shaft attached to the lifting assembly of the lifting vehicle.

6. The system of claim 1, wherein the payload rotating device is configured such that when the payload rotating device is mounted to the lifting vehicle, the rotary actuator is disposed on an opposite side of the lifting assembly of the lifting vehicle relative to the support shaft.

7. The system of claim 1, wherein the payload rotating device is configured such that the payload abuts the lifting assembly of the lifting vehicle when the payload rotating device is mounted on the lifting assembly of the lifting vehicle and the payload rotating device is inserted into the payload.

8. The system of claim 1, wherein the payload rotating device is operable to rotate the payload at least 90 degrees when the payload rotating device is mounted on the lifting assembly of the lifting vehicle and the payload rotating device is inserted into the payload.

9. The system of claim 1, wherein the support shaft includes or interfaces with a bearing surface configured to reduce friction between the support shaft and the sleeve.

10. The system of claim 1, wherein the sleeve includes or interfaces with a bearing surface configured to reduce friction between the sleeve and the support shaft.

11. A payload rotating device for mounting to a lifting assembly of a vehicle, including:
a support shaft configured to mount to the lifting assembly such that the support shaft does not rotate;
a sleeve including sleeve external surface having a non-circular profile, wherein the sleeve is disposed about the support shaft; and
a rotary actuator attached to the support shaft and the sleeve such that when the rotary actuator is actuated, the sleeve rotates about the support shaft.

12. The payload rotating device of claim 11, wherein the support shaft includes or is interfaces with a bearing surface configured to reduce friction between the support shaft and the sleeve.

13. The payload rotating device of claim 11, wherein the sleeve includes or interfaces with a bearing surface configured to reduce friction between the sleeve and the support shaft.

14. The payload rotating device of claim 11, wherein the non-circular profile is selected from a group of shapes consisting of: a regular polygon, an irregular polygon, a polygon having one or more protruding portions, a polygon having one or more intruding portions, a circle having one or more protruding portions, and a circle having one or more intruding portions.

15. The payload rotating device of claim 11, configured to interface with a payload including a channel passing through a body of the payload, wherein the channel is configured to receive the container rotating device when inserted into the channel from outside the payload, the channel also including an internal profile configured to engage with the non-circular profile of the sleeve to prevent rotation of the payload relative to the sleeve, and wherein actuation of the rotary actuator rotates the sleeve and the container about the support shaft when the container rotating device is inserted into the container.

16. A payload, comprising:
a containment volume defined by payload walls; and
a channel defined through the payload walls and the containment volume, the channel including a non-circular internal profile.

17. The payload of claim 16, wherein a center of gravity of the payload is aligned with an axis of the channel.

18. The payload of claim 16, wherein the channel is disposed on the payload such that a center of gravity of the payload is disposed within a predetermined distance from the channel.

19. A method of rotating a payload, comprising:
affixing a payload rotating device to a lifting assembly of a vehicle, a support shaft of the payload rotating device not being rotatable relative to the lifting assembly;
disposing a sleeve about the support shaft, the sleeve including a sleeve external surface including a non-circular profile;
inserting the support shaft and sleeve into a channel of the payload, the channel including an internal profile configured to engage with the non-circular profile of the sleeve to prevent rotation of the payload relative to the sleeve; and
rotating the payload by actuating a rotary actuator of the payload rotating device to rotate the sleeve relative to the support shaft.

20. The method of claim 19, wherein inserting the support shaft into the channel of the payload further includes positioning the payload such that the payload abuts the lifting assembly of the vehicle.
